(19) United States
(12) Patent Application Publication
(10) Pub. No.: US 2007/0205225 A1
(43) Pub. Date: Sep. 6, 2007

(54) Method for providing a fertilizer and a fertilizing system

(76) Inventor: Vladimir Bomze, Hadera (IL)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/367,083

(22) Filed: Mar. 3, 2006

(51) Int. Cl. B65D 88/54; G01F 11/00

(52) U.S. Cl. 222/334

(57) ABSTRACT

A fertilizing system and a method for fertilizing are provided. The system includes: a first chamber, a first piston, a second chamber, a fertilized inlet, a fertilizer outlet and a fluid inlet. The first piston is adapted to reciprocate within the first chamber at least partially in response to a flow of fluid from the fluid inlet. The second piston is adapted to reciprocate within the second chamber at least partially in response to the reciprocal movement of the first piston. The second piston selectively enables a fertilizer to flow from the fertilizer inlet to the fertilizer outlet.

### FIELD OF THE INVENTION

The present invention relates to methods for providing a fertilizer and to a fertilizing system.

### BACKGROUND OF THE INVENTION

Various types of hydraulic motors are known in the art. They usually include a single piston that moves in response to the flow of fluids within a chamber. U.S. Pat. No. 5,465,646 of DiCarlo titled “Hydraulic motor”, and U.S. Pat. No. 3,939,755 of Tabor titled “Linear hydraulic motor”, both being incorporated herein by reference, describe prior art hydraulic engines.

Various fertilizing systems are known in the art. Electrical powered fertilizers require a power supply and are not fitted to many places in which there is no power supply or where the provision of power supply is costly.

Another type of fertilizing system includes in-line hydraulic powered fertilizing system. These systems are usually very complex, reduce the pressure within the pipeline, and should be adapted to the diameter of the pipeline in which they are placed. U.S. Pat. No. 4,859,157 of Adler, which is incorporated herein by reference, describes an in line hydraulic powered device for injecting liquid fertilizer. This device includes an axis-symmetrical housing that is adapted for insertion into the pipe line. The device also includes an axial turbine impeller that is rotatably positioned in the housing, the impeller including several vanes surrounded by a shroud and a flat, annular rim outstanding from the shroud and closely surrounded by the housing walls. The rim contains, on one or on both of its flat sides, a side-channel pump of known design which includes a plurality of radial vanes inserted into an annular portion of the flat side and a channel recessed in the adjoining housing wall portion cooperating with the annular vane portion and extending from an inlet end to an outlet end, the two ends being separated by a non-recessed wall portion. Liquid fertilizer is caused to enter the inlet end through an inlet port in the housing, is pressurized by the movement of the vanes along the channel and leaves the outlet end through an outlet port in the housing, from where it is conveyed to the irrigation pipe at a point downstream of the pump impeller.

Yet another type of fertilizing system is illustrated in U.S. Pat. No. 465,765 of Beth, which is incorporated herein by reference. Beth describes a pump for injecting fertilizer or other material into a pressurized water supply line comprises an impeller including a housing having an inlet connectable to the pressurized water supply line, an outlet vented to the atmosphere, and impeller vanes rotatably mounted within the housing to be rotated by the pressurized water flowing therethrough from its inlet to its outlet. The pump further includes an injector coupled to the impeller to inject the material into the water supply line at a point downstream of the impeller.

U.S. Pat. No. 6,921,001 of Hunt el al., which is incorporated herein by reference describers an hydraulic proportioning system having a fluid actuated motor with a driven motor shaft, the motor being in fluid communication with and powered by a fluid source. A pump is provided having a drive shaft driven by the driven motor shaft of the fluid actuated motor, and a drive clutch interconnecting the driven motor shaft and the drive shaft of the pump. An injector manifold is in fluid communication with the pump which is connectable to a chemical source. A tube is in fluid communication with the injector manifold and extends into a chamber having fluid communication with the fluid source, the chemical and fluid from the fluid source combining in the chamber and discharged therefrom.

There is a need to provide an efficient method for fertilizing and a fertilizing system.

### SUMMARY OF THE INVENTION

According to an embodiment of the invention a system is provided. The system includes a dual-piston pump and is connected to an irrigation pipe via two adaptors such as T-shaped connectors. The pump receives fluid from an irrigation component (such as an irrigation pump) at a certain pressure level and outputs fertilizer at a higher pressure. The fertilizer is provided to the irrigation system without reducing the pressure of the irrigation system.

The pipe is relatively small can be easily connected to pipes of varying diameters, using simple splitters/adaptors.

Conveniently, relatively sensitive elements such as a diaphragm do not touch the fertilizer, thus increasing their life span.

### BRIEF DESCRIPTION OF THE FIGURE

The present invention will be understood and appreciated more fully from the following detailed description taken in conjunction with the drawings in which:

FIG. 1 illustrates a system according to an embodiment of the invention;

FIG. 2 illustrates a system according to an embodiment of the invention;

FIG. 3 is a cross section of a pump, according to an embodiment of the invention;

FIG. 4 is a cross section of a pump, according to an embodiment of the invention;

FIG. 5 is a cross section of a first chamber of the pump, according to an embodiment of the invention;

FIG. 6 illustrated a flow chart of a method for fertilizing, according to an embodiment of the invention; and

FIG. 7 illustrates a system and its environment, according to an embodiment of the invention.

### DETAILED DESCRIPTION OF THE FIGURE

According to an embodiment of the invention a system is provided. The system includes a first chamber, a first piston, a second chamber, a fertilizer inlet, a fertilizer outlet, a fluid inlet. The first piston is adapted to reciprocate within the first chamber at least partially in response to a flow of fluid from the fluid inlet. The second piston is adapted to reciprocate within the second chamber at least partially in response to the reciprocal movement of the first piston. The second piston selectively enables a fertilizer to flow from the fertilizer inlet to the fertilizer outlet.

Conveniently, the first piston is connected to a diaphragm. The diaphragm moves backwards and forwards in response to flow of the fluid within different spaces within the first chamber.

Conveniently, the diaphragm has a front surface and a rear surface. The front surface of the diaphragm faces the fluid inlet. The diaphragm moves towards one end of the first chamber in response to fluid that flows towards the front surface of the diaphragm. The diaphragm moves towards another end of the first chamber in response to fluid that flows towards the rear surface.

Conveniently, the first piston defines a passageway (also referred to as inner space) for fluid that is selectively blocked (for example by an inner rod) in response to a position of the first piston. Fluid that passes the passageway flows towards the rear surface of the diaphragm.

Conveniently, the first chamber and the second chamber are connected by an inter-chamber pipe. This pipe enables fluid to flow from one chamber to the other, during different phases of the pumping sequence.

Conveniently, the first piston enables passage of fluid from the first chamber, via the inter-chamber pipe, to the second chamber at least when the first piston is relatively proximate to the other end of the first chamber. Especially, the first piston and one or more annular seals can define a passageway from the intermediate space of the first chamber to the fluid outlet or defines a passageway from the fluid outlet (that acts as a fluid inlet) towards the drain outlet.

Conveniently, the first piston enables passage of fluid from the second chamber and towards a drain outlet within the first chamber at least when the second piston starts to move towards a first end of the second chamber.

Conveniently, the first chamber and the second chamber are substantially parallel to each other.

Conveniently, the second piston is connected to a rear disk and to a front member. A rear surface of the rear disk faces an inter-chamber fluid inlet. The read disk moves towards one end of the second chamber at least partially in response to fluid that flows towards the rear surface of the rear disk. The rear disk moves towards another end of the second chamber at least partially in response to a spring that contacts the read risk.

Conveniently, the fertilizer outlet is connected via at least one fertilizer pipe and at least one fertilizer valve to an irrigation pipe.

Conveniently, the second piston is connected to a front member and the fertilizer inlet, the fertilizer outlet and the second chamber define a fertilizer space through which fertilizer can flow from the fertilizer inlet to the fertilizer outlet. The rear disk and the front member are shaped such as to allow the system to output the fertilizer at a pressure that is higher than a pressure of the fluid the is provided via the fluid inlet. Conveniently, the cross section of the first member is smaller than the cross section of the rear disk.

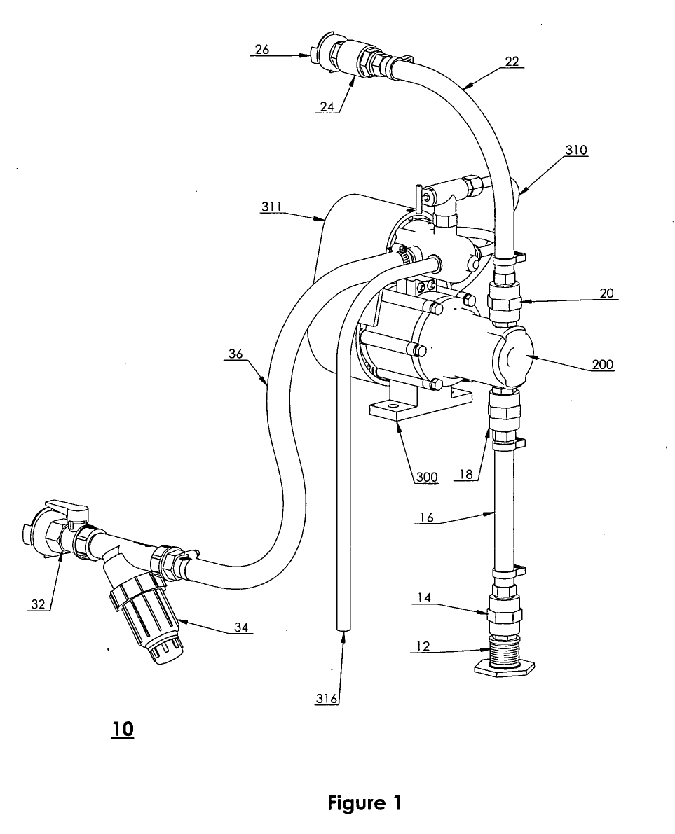

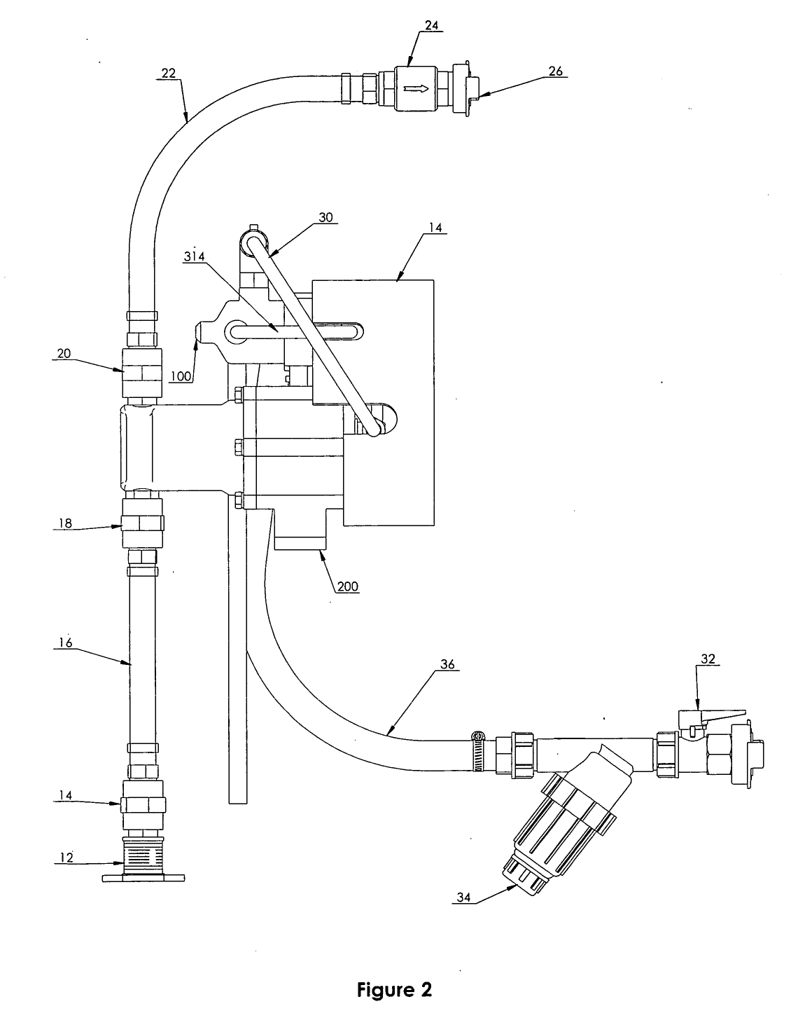

FIGS. 1 and 2 illustrate system 10 according to an embodiment of the invention.

System 10 includes multiple components. Some of these components are illustrated in FIG. 1 while others are illustrated in other figures.

System 10 includes an initial fertilizer inlet 12, a first fertilizer unidirectional valve 14, a fertilizer pipe 16, a second fertilizer unidirectional valve 18, a dual-chamber pump 200, a third fertilizer unidirectional valve 20, a second fertilizer pipe 22, a fourth fertilizer unidirectional valve 24, an output adapter 26, a drain pipe 316, a fluid tap 32, a fluid filter 34, a fluid pipe 36, an inter-chamber pipe 310, a first chamber pipe 314, and a connecting element such as rod 306.

The first till fourth unidirectional valves 14, 18, 20 and 24 allow the fertilizer to flow towards the output adapter 26. Accordingly, when pump 300 sucks the fertilizer it flows from tank 11 towards pump 300 and into pump 300. When the pump 300 outputs the fertilizer the fertilizer flows towards the output adapter 26.

The fertilizer passes though a fertilizer path that starts by tank 11. Tank 11 is followed by initial fertilizer inlet 12, first fertilizer unidirectional valve 14, fertilizer pipe 16, second fertilizer unidirectional valve 18, fertilizer inlet 220 of pump 300, a selectively opened fertilizer space 226 of pump 300, a fertilizer outlet 222 of pump 300, third fertilizer unidirectional valve 20, second fertilizer pipe 22, fourth fertilizer unidirectional valve 24 and output adapter 26.

Conveniently, the selectively opened fertilizer space is defined by the second chamber 200 (and especially a front end of the second chamber) and a frontal surface of a first member. Conveniently, the frontal surface of the first member is curved. It can have, for example, a U cross section. The front end of the second chamber has a shape that corresponds to the shape of the frontal surface of the first member. This shape smoothes the pumping operation and enables to suck the fertilizer without a preliminary step of draining air that is located in the fertilizer pipe 16. Accordingly, system 10 is adapted to suck the fertilizer (and then pump it out) to a curved space 226.

According to various embodiments of the invention the frontal surface may include stairs, straight lines, and the like, as long as the frontal surface is not a straight ling that is perpendicular to an imaginary axis of the second chamber.

Conveniently, the first unidirectional valve 14 is placed in proximity to the initial fertilizer inlet 12, the second unidirectional valve 18 is placed in proximity to the fertilizer inlet 220, the third unidirectional valve 20 is placed in proximity to the Fertilizer outlet 224 and the fourth unidirectional valve 24 is placed in proximity to the output adapted 26.

Fluid flows from tap 32 towards fluid filter 34 then flows through fluid pipe 36 and enters the second chamber 200 of pump 300 via fluid inlet 154. The fluid usually flows within the first chamber 100. It can then flow via the inter-chamber pipe 310 to the second chamber 310. The fluid flows within the second chamber 200 and then flows via the inter-chamber pipe 310 towards the first chamber 100. The fluid then finally exits pump 300 through the drain pipe 316. These various stages of fluid flow will be illustrated in greater details below.

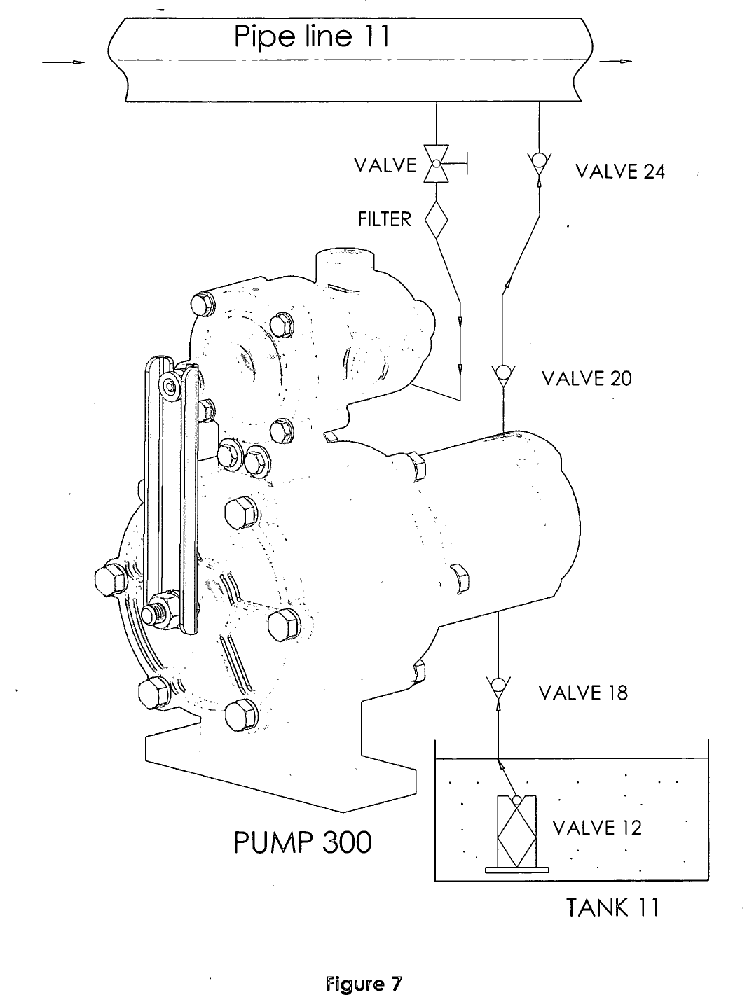

FIG. 7 illustrates system 10 and its environment, according to an embodiment of the invention.

FIG. 7 illustrates the connection between the system 10 and a pipeline 13. Fluid is provided to pump 300 by a connector that directs some of the fluid that flows through the pipeline 13 towards the pump 300. Another connector enables fertilizer to be provided to the pipeline 13. The pressure of the fertilizer that exits system 10 is higher than the pressure of the fluid that flows through pipeline 13. Thus the system 10 can receive fluid and output fertilizer.

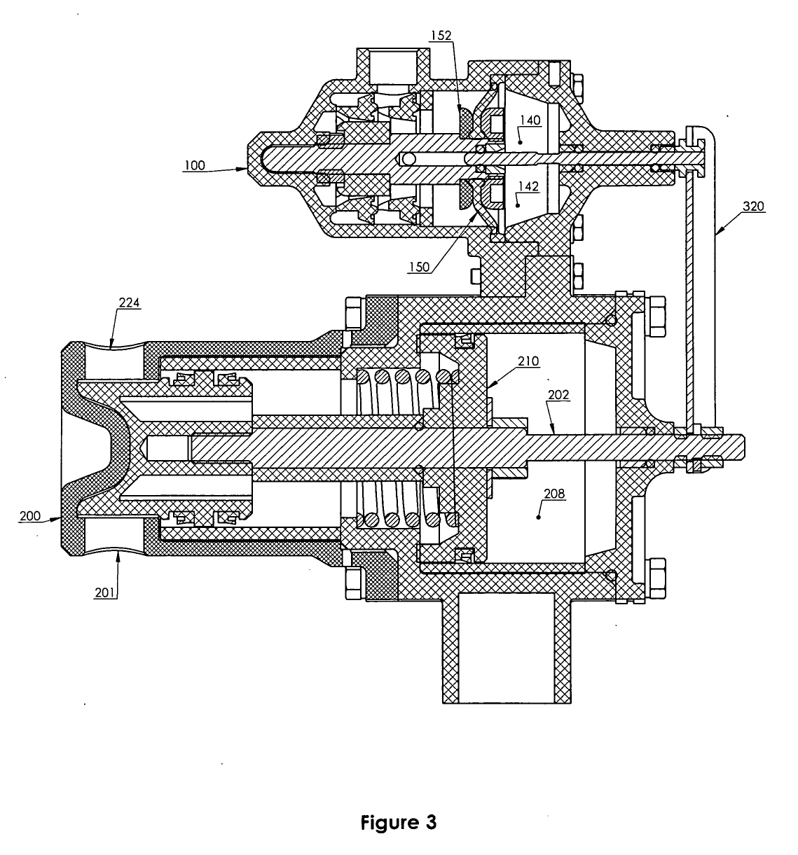

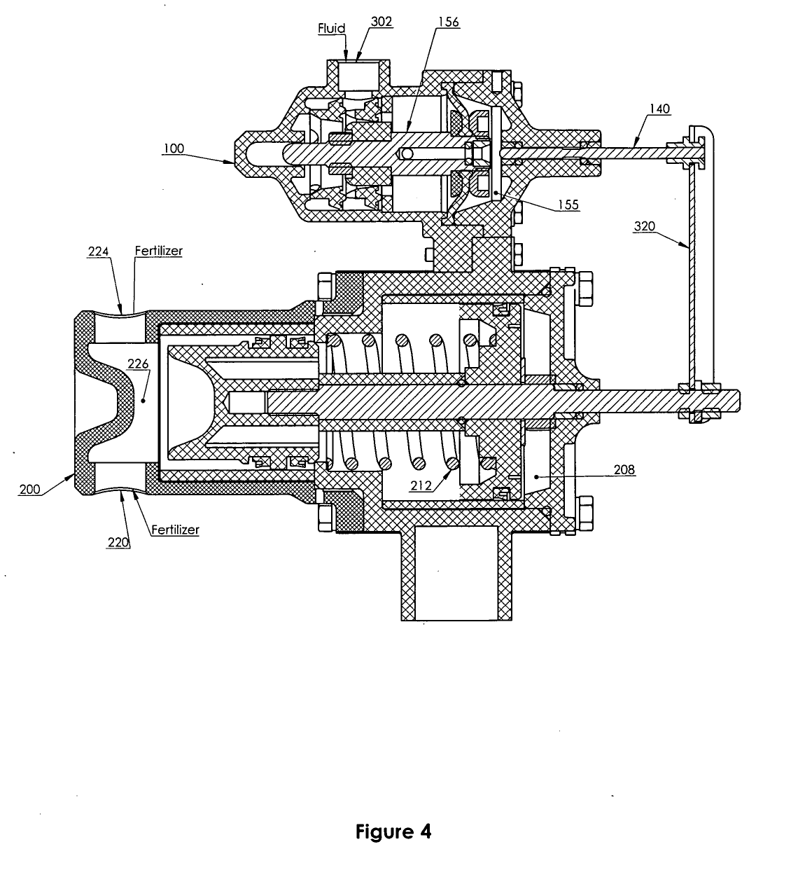

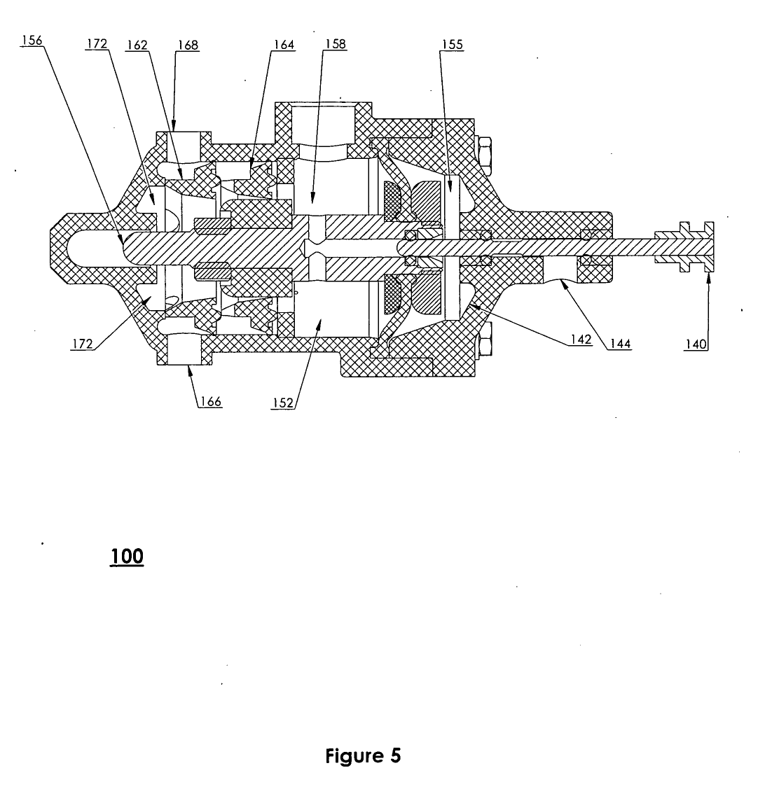

FIGS. 3 and 4 illustrate cross sections of pump 300 according to an embodiment of the invention. FIG. 5 illustrates a cross section of first chamber 100 according to an embodiment of the invention.

FIG. 3 and FIG. 4 illustrate a cross section of pump 300 that is made across an imaginary vertical plane while FIG. 5 is a cross section of first chamber 100 that is made across an imaginary horizontal plane.

In relation to FIGS. 3-5 the lower end of pump 300 will be referred to as front end while the upper end will be referred to as the rear end. In addition, holes, spaces, components or component portions that face the upper end of pump 300 or are positioned closer to the upper end of the pump are referred to as rear holes, rear spaces, rear components and rear component portions respectively.

Pump 300 includes a first chamber 100, a second chamber 200, an inter-chamber pipe 310, a first chamber pipe 314, a drain pipe 316, a first piston bore 138, a rear piston fluid outlet 141, an annular fluid concentrator element 144, diaphragm 150, fluid inlet 154, a first piston rear cavity 155, a first piston 156, a first piston front cavity 158, a front annular seal 162, a rear annular seal 164, a front fluid inlet 166, a drain outlet 168.

First chamber 100 as well as some of the mentioned above elements define three major spaces—a rear space 142, an intermediate space 152 and a front space 172. The rear space 142 is defined by the rear surface of diaphragm 150, the first piston 156, and a diaphragm supporter 144. The intermediate space 152 is defined by the front surface of diaphragm 150, the first piston 156 and rear annular seal 164. The front space 172 is defined by the first chamber 100, the front end of first piston 156, front annular seal 162 and rear annular seal 164.

Fluid enters the intermediate space 152 via fluid inlet 153. The first piston 156 starts to move forwards when fluid passes from the intermediate space 152 towards the rear space through first piston front cavity 158, through an inner space 159 defined within the first piston 156 and through first piston rear cavity 155 to rear space 142. The fluid forces the diaphragm 150 to move forwards. At some stage of the forward movement of the first piston 156 the inner space 159 is blocked by inner rod 140 that slides within inner space 159 of the first piston 156.

In addition, the rear annular seal 164 allows fluid to flow from the intermediate space 152, via fluid outlet 302, through inter-chamber pipe 310, through a fluid inlet 206 positioned near a rear end of the second chamber 200. The fluid enters a rear space 208 defined by the second chamber 200, the second piston 202 and a rear face of rear disk 210 connected to the second piston 202.

The fluid forces the rear disk 210 and accordingly the second piston to move forward, while pressing spring 212. A front member 228 is connected to the second piston 202, and conveniently surrounds the front end of first piston 202.

The front member 228, fertilizer inlet 220, fertilizer outlet 224 and second chamber 200 define a fertilizer space 226 through which fertilizer can flow from the fertilizer inlet 220 to the fertilizer outlet 224. When the second piston 202 moves forward the fertilizer space 226 is gradually closed and fertilizer that was sucked into that space is forced to exit space 226 via the fertilizer outlet.

After the first and second pistons 156 and 202 are positioned at their most frontal position they start to move backwards due the movement of spring 212 and due to fluid within intermediate space 152 that push diaphragm 150 from its most frontal position. The forward movement of second piston 202 forced fluid to exit rear space 208 and flow through fluid outlet 206, inter-chamber pipe 310, fluid inlet 302 to intermediate space 152. In addition, the backward movement of diaphragm 150 pushed water from the rear space 142 via rear piston fluid outlet 140, first chamber pipe 314 and front fluid inlet 166 to front space 172 and towards drain pipe 316.

TABLE 1 illustrates various stages in the operation of pump 300.

TABLE 1

| | | | Fluid within | |
|---|---|---|---|---|
| | First | Fluid within first | second | |
| | piston | chamber | chamber | fertilizer |
| Initial state | Most | Flows from | Empty | Fills the |
| (illustrated in | backward | intermediate space | | fertilizer space 226 |
| FIG. 4) | position | 152 to rear space | | |
| | | 142 | | |
| First phase of | Moves | Flows from | Flows from | Being forced |
| pumping | forward | intermediate space | inter-chamber | out of the |
| sequence | | 152 to rear space | pipe 310 to | fertilizer space |
| | | and forces | fluid inlet 206 | 226 |
| | | diaphragm 150 to | and forces first | |
| | | move forward. | piston to move | |
| | | Flows from | forward. | |
| | | intermediate space | | |
| | | 152 through fluid | | |
| | | outlet 302 to inter- | | |
| | | chamber pipe 310 | | |
| Second phase | Moves | Flows from | Flows from | Being forced |
| of pumping | forward | intermediate space | inter-chamber | out of the |
| sequence | | 152 through fluid | pipe 310 to | fertilizer space |
| | | outlet 302 to inter- | fluid inlet 206 | 226 |
| | | chamber pipe 310 | and forces first | |
| | | | piston to move | |
| | | | forward. | |
| Third phase of | Most | Flows from | Flows from | Fertilizer |
| pumping | forward | intermediate space | inter-chamber | space 226 is |
| sequence | position | 152 through fluid | pipe 310 to | closed |
| (illustrated in | | outlet 302 to inter- | fluid inlet 206 | |
| FIG. 4) | | chamber pipe 310 | and forces first | |
| | | | piston to move | |
| | | | forward. | |
| Fourth phase | Moves | Flows from rear | Flows from | Fertilizer |
| of pumping | backwards | space 142 via first | rear space 208 | space 226 is |
| sequence | | chamber pipe 314 to | to inter- | being filled |
| | | front space 172 | chamber pipe | with fertilizer. |
| | | towards drain pipe | 310 to front | |
| | | 316. | space 172 | |
| | | Flows within | towards drain | |
| | | intermediate space | pipe. | |
| | | 152 and forces | | |
| | | diaphragm 150 to | | |
| | | move backwards. | | |

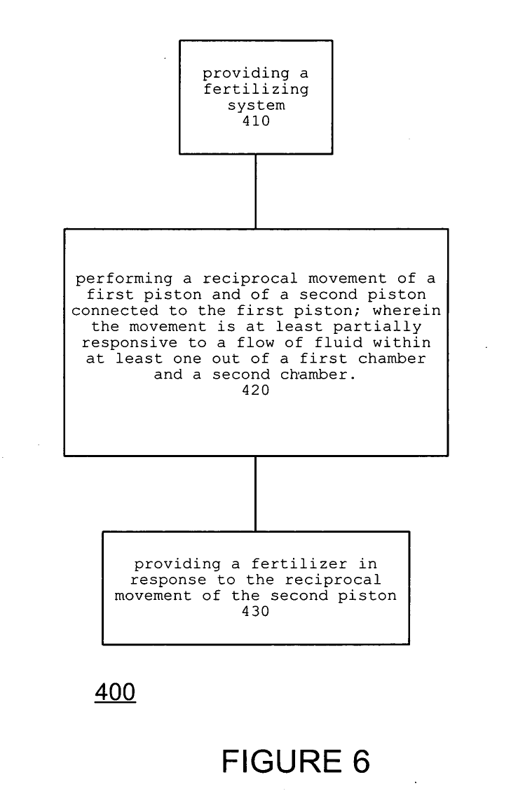

FIG. 6 illustrated a flow chart of a method 400 for fertilizing, according to an embodiment of the invention.

Method 400 can start by stage 410 of providing a fertilizing system such as but not limited to system 10.

Stage 410 is followed by stages 420 and 430. Stage 420 includes performing a reciprocal movement of a first piston and of a second piston connected to the first piston; wherein the movement is at least partially responsive to a flow of fluid within at least one out of a first chamber and a second chamber.

Stage 420 is followed by stage 430 of providing a fertilizer in response to the reciprocal movement of the second piston.

Conveniently, stage 420 includes reciprocally moving a diaphragm connected to the first piston. Conveniently, stage 420 includes moving the diaphragm forward in response to a flow of fluid that flows towards a rear surface of the diaphragm and moving the diaphragm backwards in response to a flow of fluid towards a front surface of the diaphragm.

Conveniently, stage 420 includes selectively allowing the fluid to flow via a passageway towards the rear surface of the diaphragm.

Conveniently, stage 420 includes allowing fluid to flow between the first chamber and the second chamber.

Conveniently, the first chamber and the second chamber are substantially parallel to each other.

Conveniently, stage 420 includes receiving fluid at a certain pressure level and stage 430 includes providing a fertilizer at a pressure level that is higher than the certain pressure level.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

What is claimed is:

1. A fertilizing system comprising: a first chamber, a first piston, a second chamber, a fertilized inlet, a fertilizer outlet, a fluid inlet; wherein the first piston is adapted to reciprocate within the first chamber at least partially in response to a flow of fluid from the fluid inlet; wherein the second piston is adapted to reciprocate within the second chamber at least partially in response to the reciprocal movement of the first piston; whereas the second piston selectively enables a fertilizer to flow from the fertilizer inlet to the fertilizer outlet.

2. The system of claim 1 wherein the first piston is connected to a diaphragm; wherein the diaphragm reciprocates in response to flow of the fluid within different spaced within the first chamber.

3. The system of claim 1 wherein the first piston is connected to a diaphragm; wherein the diaphragm has a front surface and a rear surface; wherein the front surface of the diaphragm faces the fluid inlet; wherein the diaphragm moves towards one end of the first chamber in response to fluid that flows towards the front surface of the diaphragm; and wherein the diaphragm moves towards another end of the first chamber in response to fluid that flows towards the rear surface.

4. The system of claim 3 wherein the first piston defines a passageway for fluid that is selectively blocked in response to a position of the first piston; wherein fluid that passes the passageway flows towards the rear surface of the diaphragm.

5. The system of claim 1 wherein the first piston defines a passageway for fluid that is selectively blocked in response to a position of the first piston.

6. The system according to claim 1 wherein the first chamber and the second chamber are connected by an inter-chamber pipe.

7. The system according to claim 6 wherein the first piston enables passage of fluid from the first chamber, via the inter-chamber pipe, to the second chamber at least when the first piston is relatively proximate to the other end of the first chamber.

8. The system according to claim 6 wherein the first piston enables passage of fluid from the second chamber and towards a drain outlet within the first chamber at least when the second piston starts to move towards a first end of the second chamber.

9. The system according to claim 1 wherein the first chamber and the second chamber are substantially parallel to each other.

10. The system according to claim 1 wherein the second piston is connected to a rear disk and to a front member; wherein a rear surface of the rear disk faces a inter-chamber fluid inlet; wherein the read disk moves towards one end of the second chamber at least partially in response to fluid that flows towards the rear surface of the rear disk; and wherein the rear disk moves towards another end of the second chamber at least partially in response to a spring that contacts the read risk.

11. The system according to claim 10 wherein the front member, the fertilizer inlet, the fertilizer outlet and the second chamber define a fertilizer space through which fertilizer can flow from the fertilizer inlet to the fertilizer outlet; and wherein the rear disk and the front member are shaped such as to allow the system to output the fertilizer at a pressure that is higher than a pressure of the fluid the is provided via the fluid inlet.

12. The system according to claim 1 wherein the fertilizer outlet is coupled via at least one fertilizer pipe and at least one fertilizer valve to an irrigation pipe.

13. The system according to claim 1 wherein the system is adapted to suck fertilizer into a curved space.

14. A method for fertilizing, the method comprises: performing a reciprocal movement of a first piston and of a second piston connected to the first piston; wherein the movement is at least partially responsive to a flow of fluid within at least one out of a first chamber and a second chamber; and providing a fertilizer in response to the reciprocal movement of the second piston.

15. The method according to claim 14 wherein the performing a reciprocal movement comprises reciprocally moving a diaphragm connected to the first piston.

16. The method according to claim 14 the system of claim 1 wherein the reciprocally moving a diaphragm connected to the first piston comprises moving the diaphragm forward in response to a flow of fluid that flows towards a rear surface of the diaphragm and moving the diaphragm backwards in response to a flow of fluid towards a front surface of the diaphragm.

17. The method according to claim 14 further comprising selectively allowing the fluid to flow via a passageway towards the rear surface of the diaphragm.

18. The method according to claim 14 further comprising allowing fluid to flow between the first chamber and the second chamber.

19. The method according to claim 14 wherein the first chamber and the second chamber are substantially parallel to each other.

20. The method according to claim 14 further comprising receiving fluid at a certain pressure level and providing a fertilizer at a pressure level that is higher than the certain pressure level.
